(19) United States
(12) Patent Application Publication
(10) Pub. No.: US 2014/0032621 A1
(43) Pub. Date: Jan. 30, 2014

(54) Simple and Fast Method to Find Inside Points

(71) Applicant: YikLoon Lee, Leonardtown, MD (US)

(72) Inventor: YikLoon Lee, Leonardtown, MD (US)

(21) Appl. No.: 13/940,454

(22) Filed: Jul. 12, 2013

Related U.S. Application Data
(63) Continuation-in-part of application No. 12/701,230, filed on Feb. 5, 2010, now abandoned.

(51) Int. Cl. G06F 17/10

(52) U.S. Cl. CPC G06F 17/10
USPC 708/200

(57) ABSTRACT

A commonly recurring computational geometry problem in many diverse science and engineering disciplines is to determine if a point is inside an enclosed body. Usually this needs to be solved for a very large set of points. Many algorithms for different applications have been proposed. But fundamentally, they are all based on the same underlying strategy of focusing solely on the 2D body surface as the defining boundary. For a general solution, these traditional algorithms remain very complex and computationally costly. A new concept for a simple and efficient approach not specifically tied to any application is described here.

### BACKGROUND OF THE INVENTION

This invention is about a new concept that results in a simple and fast method to solve a common computational geometry problem : to numerically determine which, if any, in a large logically linked set of (evaluation) points (where every point is numbered and has at least one known neighbor) are inside or outside one or more fully enclosed bodies (defined and bounded by many flat surface panels with given coordinates) with any complex arbitrary shape (such as the thick red outline in FIG. 1a, or FIGS. 3 and 4). This is also known as the point-in-polygon problem and has diverse applications where geometrical data is processed.

a) Focusing solely on the 2D body surface as the defining boundary relative to the tested point, traditional methods take an obvious and direct approach to determine (utilizing various invented techniques) independently for every point if it is inside or outside.

b) One such method, widely known as ray casting algorithm (not to be confused with a computer graphics rendering technique with a similar name), constructs a straight line (called ray) starting from the tested point going in any arbitrary direction to infinity. The number of times this line intersects the 2D body surface determines the inside/outside status of the tested point—odd number indicates inside, otherwise outside. The explanation of this observation is not pursued here but is widely available. This algorithm is repeated for every point.

c) Other traditional methods are available. But the crux is the use of 2D body surface for the geometrical processing, and is the foundation and common thread for all these methods. This is only to be expected, since the 2D body surface is what defines the original problem. While these methods are conceptually not difficult for less complex shape, their fully implemented algorithms are necessarily complicated, bulky and numerically expensive because of the requirements to handle any arbitrary and extremely complex surface shape with millions of surface panels.

d) In contrast, this invention does not directly involve or process the 2D body surface. The complexity of surface shape is thus much less relevant.

### SUMMARY OF THE INVENTION

The heart of this invention is to avoid treating the 2D body surface as the boundary and replace it with an extended and bulkier but, for the purpose of this geometrical processing problem, equivalent 3D boundary zone. Compared with the 2D body surface preferred by traditional methods, this equivalent zone is simpler and faster to work with, and thus tremendously reduces algorithmic complexity and shortens software development time.

### DESCRIPTION OF THE FIGURES

FIG. 1 An arbitrarily shaped body. Black points inside the body are separated from those outside the extended body by enlarged red points that are in the zone of 3D cells (an enlarged view in b).

FIG. 2 Some regularly shaped bodies (3D convex cells).

FIG. 3 a,b) A representative wind turbine-blades assembly showing surface panels. c) A large set of test points taken from a rectangular block of uniform cubic cells. d) Boundary zones of surrounding 3D cells.

FIG. 4 Diagram of a body with highly complex 2D surface shape—ship with a helipad, cranes and various structures.

### DETAILED DESCRIPTION

### Preliminaries

a) For many applications, an equivalent variation of the problem is more convenient: instead of finding the inside points directly, find the outside points bordering the inside points (or bodies). Although these bordering points are not bounded and not as easily defined as inside points, their identification would logically isolate all inside points.

b) The new concept takes a different and indirect approach to the problem and naturally avoids the inherent difficulties of traditional methods. The crux of the concept is based on three simple characteristics irrelevant to traditional methods.

c) The first is the recognition of the simple fact that the problem becomes quite trivial if the body in [0001] is a regularly shaped convex enclosed space defined and bounded by just a few flat surface panels like those in FIG. 2.

a) Thus it seems one obvious method would be to first fill the entire space inside the arbitrary bodies with smaller version of these regularly shaped bodies (called 3D cells here). If a point is, after a search through the cells, found to be inside one of these cells, then it is inside a body. (Note: The required cell search method is quite standard and thus not described here.)

b) But in many situations, this could be tedious and impractical.

c) It is important to note that, because of the large startup cost, this new concept which relies on simple cell search and navigation makes economic sense only if the number of evaluation points is large.

### The Concept: Replacing the Boundary Surface with a 3D Zone

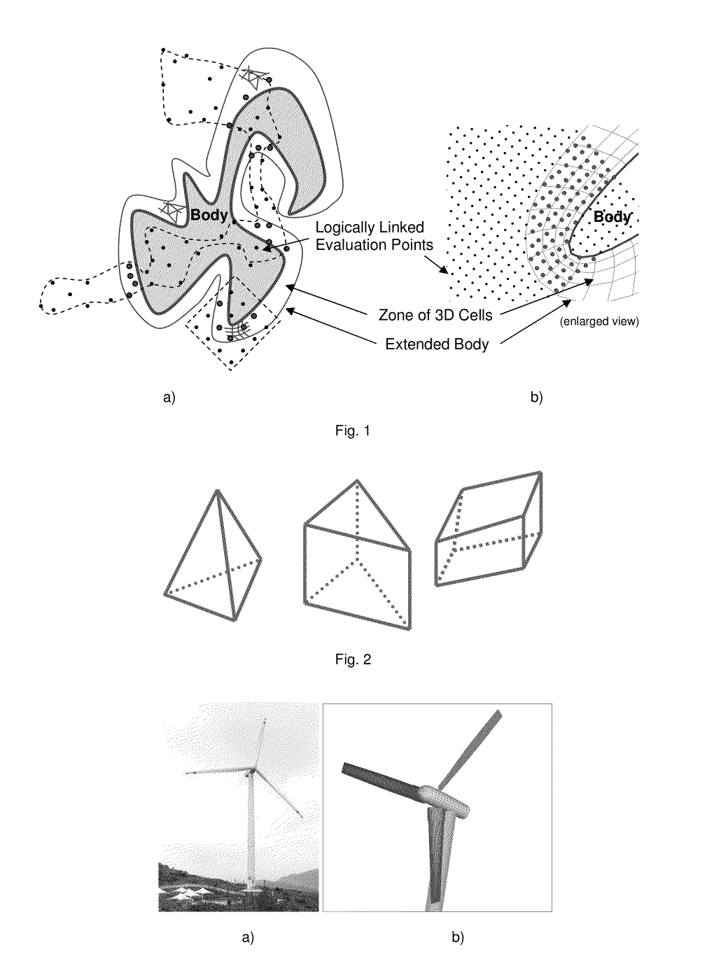

a) The second is the realization that a similar effect to [0005] can be achieved by doing the same from the opposite end, that is, by filling some of the space immediately outside the bodies with 3D cells (see “Zone of 3D Cells” in FIG. 1).

b) One advantage of this opposite approach is that these cells only need to fill the space up to a certain extent away from (but not too close to) the body surface. The procedure to determine the extent is not part of the claim here and there is considerable leeway in its determination. But, like the body surface, the cells must completely surround the bodies. Another advantage is, in many situations, these external cells are either already available or easy to generate. The body plus the boundary zone of 3D cells can be considered informally as the extended body (thin red outline in FIG. 1) the shape of which may no longer reflect the original body.

c) For all geometrical processing purposes, this zone of cells attached to the body surface now replaces that surface as the designated boundary zone and the surface subsequently loses its traditional significance.

### The Concept: Replacing (Again) the Boundary Zone

a) Those points that, after the standard cell search process, are found anywhere inside this zone of cells are marked (shown in FIG. 1a, b as red and enlarged).

b) The third and last critical characteristic to note is that these marked points too, similar to the body surface or its attached cell zone, always serve as a dividing boundary to logically separate those points that are inside the body and those that are outside the extended body (inside and outside black points in FIG. 1). In effect, the zone of 3D cells is now replaced (once again) by a subset of evaluation points as the boundary zone.

c) Since all inside points are now logically isolated, the original problem is now, at least in principle, solved. Because all points are logically linked, the inside points can be subsequently found one by one following the link.

### EXAMPLES

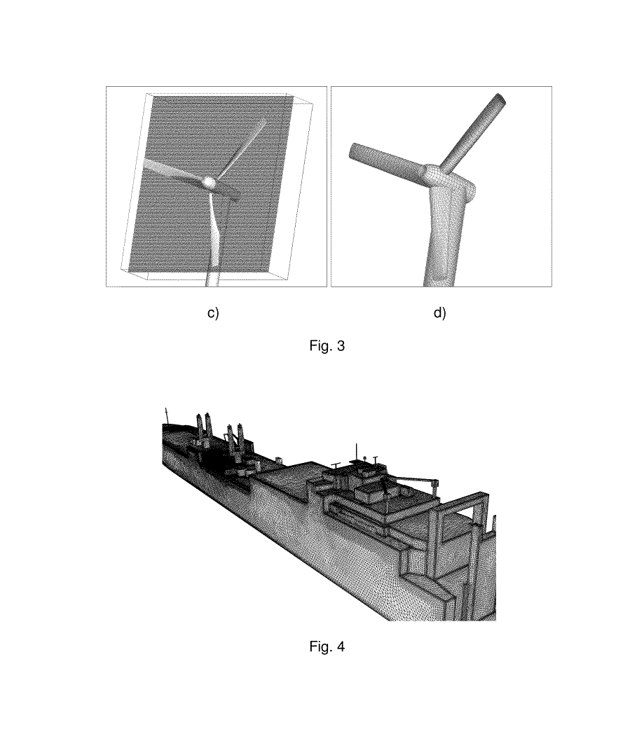

a) FIG. 3 shows an example of a representative wind turbine-blade assembly for electricity generation where geometrical data are processed and this invention is useful in the design/analysis process. The performance of a particular wind turbine design can be determined in a computer simulation by knowing, for a given background wind speed, what the surrounding air pressure and velocity is everywhere around the turbine. Here, everywhere necessarily means sampling with a finite but large set of points (could number in the millions) fixed in space. While these points can be somewhat arbitrarily distributed in space, for simplicity sake in FIG. 3c, they are taken as the corner points of a set of uniform cubic cells that fill a rectangular block. Because of the rotation and arbitrary orientation of the wind turbine blades, some of these points would, from time to time, find themselves going inside (and subsequently coming out of) the blades. During a continuous simulation, it is necessary to know, at all time, which points are inside.

b) As described earlier, the first step is to create the boundary zone of 3D convex cells (like those in FIG. 2) that completely surround the turbine and blades. Starting with the coordinates of the flat surface panels that define all body shapes given in the turbine design, this can be done quite easily (FIG. 3d) using readily available public or commercial software (such as NetGen or Ansys). The technology to create such zone of 3D cells from surface panels is quite mature.

c) Find Enclosing Cells—Once this boundary zone is obtained, the next step is to test for each and every point if it is inside any of the 3D cells in this zone. Initially for the first point, one cell is arbitrarily chosen as a first guess for such a test. Whether a point is inside this simple convex cell enclosed by only a few flat surface panels is quite easily tested by applying basic vector analysis to each of the surface panels relative to a fixed line connecting the point to the cell centroid. If the point is inside, all panels would return negative results. Otherwise one of them would return a positive result, in which case the neighboring cell sharing the panel that returns positive result is similarly tested next. This test operation is repeated on different cells until either a cell is eventually found to contain the point, or a pre-defined criterion stops this cell-to-cell movement and declares that no cell is found. One possible criterion requires the construction and utilization of a big rectangular box (which is the simplest convex shape) that is big enough to contain the entire boundary zone of cells. All remaining void in the box not occupied by this zone is also filled with similar cells. These cells, however, are marked, so that they can be distinguished from those original cells in the zone. The above tests are performed within this box that is completely filled with cells. Then the point is definitely not in the zone if either a marked cell is found to contain the point, or the test comes to a cell at the box boundary and the next move leads to outside the box.

d) Optimal Point-to-Point Progression Pattern—The above procedure in c) is repeated for all points, any one of which could be chosen as the starting or ending point, with any point-to-point progression pattern. However, the number of cell-to-cell moves needed to complete all necessary tests for any particular point would be very small, or even zero, if the progression could proceed orderly from neighbor to neighbor, i.e., consecutive points are not randomly selected. This is because the initial guess of which cell to be tested first for a particular point should be quite accurate (i.e. the point should be near, or even inside, this initial cell) if it is chosen, not arbitrarily, but to be the last cell tested for the previous point, since any pair of consecutive points are also nearby neighbors.

e) Those points found to be in the boundary zone of 3D cells are the bordering points, mentioned in the problem statement [0004] a), that fully enclose and isolate the body and its inside points. These inside points are found, not directly, but through isolation, thus equivalently solving the original problem.

a) Another application with extreme surface complexity that needs similar geometrical processing is a ship in FIG. 4 with a helipad, cranes and various structures of different sizes. For reasons of safe helipad operations and design simulations under windy and gusty conditions, it is desirable to simulate the surrounding air velocity, which is heavily influenced by these near-by structures. As in previous example, the velocity is sampled on a large set of points in the vicinity of the ship deck. Some of these points fall inside the various fixed and movable ship structures and need to be identified.

b) A boundary zone of 3D cells is constructed using the above mentioned software (e.g. NetGen or Ansys). Those points that fall in this zone are similarly determined using basic vector analysis. The procedures are the same as those described in [0008] c, d, and e.

### SUMMARY

a) In summary, this new concept transforms the original problem A) of in/out status described in [0001] that uses the 2D body surface as the defining in/out boundary, to an equivalent problem B) that uses the zone of additionally generated 3D cells completely surrounding the body as the new in/out boundary zone. The latter problem is to determine which points are inside that zone. This is much easier and faster to solve than the original problem A) because of [0004]c) above, and any quick standard cell search technique suffices. Cell search is where almost all the computation lies. The search results effectively transforms the problem B) yet again into another, C), that uses the points in the zone of 3D cells (as opposed to the body surface in A or the cell zone itself in B) as the new in/out logical boundary zone to isolate the inside points.

b) In exchange for its advantages, this new concept requires that a zone of 3D cells be present and that the evaluation points be logically linked, neither of which is demanding in many situations.

c) In effect, the concept merely transforms the dividing boundary from 2D body surface to a subset of evaluation points. Instead of asking which points are inside the 2D enclosed surface, the question becomes which points are inside the 3D boundary zone enclosing this surface.

d) The details explained in [0006] and [0007] are the heart of this new concept.

The two root causes of the algorithmic complexity and inefficiency of traditional methods for large number of evaluation points are a) the focus on the possibly highly complicated 2D body surface as the defining boundary which the new concept avoids by transformations to an operationally simpler but equivalent problem, and b) the inability to amortize the cost of (i.e., utilizing results from) other previously evaluated points. In contrast, cell searches for large number of points can be significantly accelerated by amortizing the cost.

We claim:

1. a new concept that results in a simple and fast method to numerically determine which, if any, in a large logically linked set of points are inside or outside one or more fully enclosed bodies (defined and bounded by many flat surface panels) with any complex arbitrary shape.

2. (canceled)

3. (canceled)

4. (canceled)

2. Replacing the 2D Boundary Surface with a 3D Boundary Zone—For geometrical data processing, it is advantageous to replace the 2D body surface with a zone of 3D cells attached to and completely surrounding the said surface as the designated boundary zone. The surface loses its traditional importance as the dividing boundary. While it seems less well defined than the body surface, the new zone of cells allows the use of a standard cell search procedure to find the points in the zone.

5. (canceled)

6. (canceled)

7. (canceled)

3. Replacing (Again) the 3D Boundary Zone—The points that are found (using a cell search procedure) anywhere inside the boundary zone always serve, similar to the 2D body surface or its attached 3D zone of cells, as a dividing boundary to logically isolate those points inside the body from the rest. In effect, the original 2D body surface is replaced by a subset of evaluation points (bordering the inside points) as the final boundary representation. Since all inside points are now logically isolated, they can be easily identified. The original problem is thus, in principle, solved.
